(19) United States
(12) Patent Application Publication
(10) Pub. No.: US 2010/0241523 A1
(43) Pub. Date: Sep. 23, 2010

(54) METHOD AND SYSTEM FOR LEAD AUCTION

(76) Inventor: Mayur RAICHURA, North Potomac, MD (US)

Correspondence Address: ARENT FOX LLP, 1050 CONNECTICUT AVENUE, N.W., SUITE 400, WASHINGTON, DC, 20036, US

(21) Appl. No.: 12/726,008

(22) Filed: Mar. 17, 2010

Related U.S. Application Data
(60) Provisional application No. 61/161,326, filed on Mar. 18, 2009.

(51) Int. Cl. G06Q 30/00

(52) U.S. Cl. 705/26

(57) ABSTRACT

Systems and methods for a managing entity to provide a marketplace approach for matching leads with sales associates, and to determine the percentage of commission a sales associate may be willing to pay for the option of exploring and following-up on the lead are disclosed. An option percentage of commission may not be payable in advance by the sales associate to the lead, and may be provided in the form of a promise to pay a percentage of the sales associate's commission, or other amount certain, upon a successful conclusion of a transaction with the lead. A referral commission may also be owed by the party winning the bid to the management entity.

This application claims priority from provisional U.S. patent application No. 61/161,326, filed on Mar. 18, 2009, the contents of which is incorporated in its entirety herein.

### BACKGROUND OF THE INVENTION

1. Field of the Invention

This application relates generally to a method and system for providing a lead auction platform, and more specifically to providing a market-driven platform that allows sales associates to bid on leads via an auction, and to determine the value of following-up on a lead.

2. Related Art

Lists of real estate properties for sale or rental are available at real estate agencies and/or other financial institutions. In addition, potential buyers, renters, or facilitators representing potential buyers or renters, of real estate properties often contact real estate agencies with requests for information in general, or expressing interest with respect to specific properties, in particular. Such “leads” i.e. properties available for sale or rental and/or potential buyers, renters, or facilitators representing potential buyers or renters, may be identified or received from a variety of sources, such as lists of properties for sale/rental at a given real estate agency, classified newspaper advertisements, and Internet postings, among others sources. Following up on such leads may result in successfully completing a real estate transaction.

There exist in the art methods and systems for matching real estate leads with sales associates who follow-up on those leads. These methods and systems are, however, deficient in several respects. The matching may be based on geographic location or other criteria, such as personal affiliation, for example. If the sales associate who follows up on a given lead is successful in concluding a real estate transaction, the real estate agency receives a fee or commission, which is split with the sales associate based on a pre-negotiated basis. Alternatively, the real estate agency/financial institution may receive a fee from the sales associate, which is typically a percentage of the commission earned by the sales associate for the successful conclusion of the transaction, or another previously agreed-upon amount between the real estate agency/financial institution and the sales associate. There is, however, no systematic market-driven approach for determining the cost of exploring the opportunity to follow-up on a given lead and, as a consequence, for determining the fees payable to the real estate agency by the sales associate upon successful conclusion of a real estate transaction on the lead.

There is a need in the art, therefore, for methods and systems that provide a platform (interchangeably referred to herein as a marketplace) that allows sales associates to bid on leads, and to specify what value they place on the opportunity to follow up on a specific lead, i.e., what percentage of their commission sales associates are willing to provide as a fee to the real estate agency upon a successful conclusion of a real estate transaction on the lead. That is, there is a need in the art for a marketplace that determines what price a sales associate is willing to pay for an opportunity, or option, to follow up on a given lead.

### SUMMARY OF THE INVENTION

Aspects of the present invention solve the above-described problems, as well as others, by providing a marketplace approach for matching leads with sales associates, and for determining the percentage of commission a sales associate may be willing to pay for the option of exploring and following-up on the lead. According to aspects of the present invention, this option percentage of commission may not be payable in advance by the sales associate, but may be provided in the form of a promise to pay a percentage of the sales associate's commission (or other amount certain) upon a successful conclusion of a transaction with the lead. It should be noted, however, that according to other aspects, the option price may be payable in advance or may be held in escrow, for example.

Additional advantages and novel features of these aspects of the invention will be set forth in part in the description that follows, and in part will become more apparent to those skilled in the art upon examination of the following or upon learning by practice of the invention.

### BRIEF DESCRIPTION OF THE DRAWINGS

FIG. 1 illustrates an exemplary block diagram of a platform for lead auction, according to various aspects of the present invention;

FIG. 2 illustrates a process for lead auctions, according to various aspects of the present invention;

FIG. 3A-3K illustrate exemplary graphic user interface (GUI) screens, in accordance with various aspects of the present invention;

FIG. 4 illustrates a computer system for implementing various aspects of the invention; and

FIG. 5 is a block diagram of various exemplary system components, in accordance with various aspects of the present invention.

### DETAILED DESCRIPTION

Example aspects of the present invention will be described below in accordance with the above unmet needs and advantages. It will be appreciated that the examples described in the following detailed description are merely illustrative of the invention and that many variations and modifications will be apparent to those skilled in the art. It should be noted that while aspects of the present invention are described below in the context of real estate leads and transactions, the present invention is applicable to any context that requires matching between potential buyers, renters, or facilitators representing potential buyers or renters, and sales associates, and determination of the price an sales associate is willing to pay to explore, or follow up, on a specific lead or other opportunity. In addition, it should be noted that although the “leads” described below are potential buyers or renters, in accordance with aspects of the present invention, these “leads” may be any option or other opportunity, such as a potential customer interested in purchasing a specific commodity, which, when matched with an sales associate, may lead to successful completion of the transaction for the commodity.

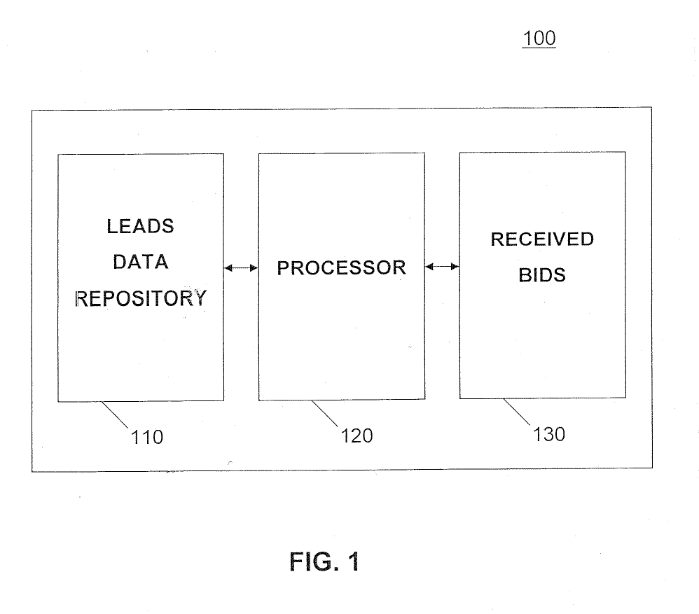

Referring now to FIG. 1, therein shown is an exemplary block diagram of a platform for lead auction 100, according to aspects of the present invention. All identified or received leads are stored in data repository 110, and are made available for bidding by sales associates who have logged into the system via, for example, email, a website, the telephone, or other communication platform including person-to-person interaction. Received bids 130 are processed via processor 120. The winning bid may be output via a user interface (not shown), such as a computer monitor, smart phone, PDA, printer, and/or audio device, among other interfaces, and complete information about the lead may be provided to the sales associate who placed the winning bid via, for example, e-mail, a web site, the telephone, or other communication platform including person-to-person interaction.

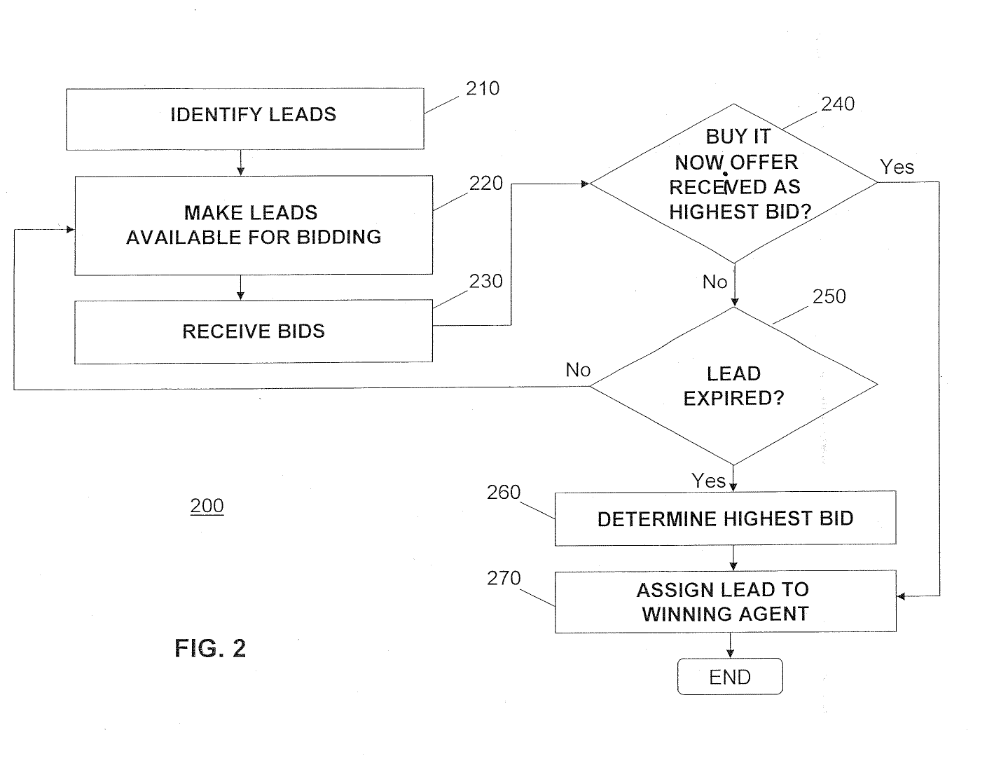

Referring now to FIG. 2, therein shown is a process for lead auctions, according to aspects of the present invention. Leads are identified or received by a management entity in 210. Leads such as, for example, potential buyers, potential renters, or facilitators representing potential buyers or renters, of real estate properties available for sale and/or for rent, may be identified from a variety of sources, such as lists of properties for sale or for rental at a given real estate agency or related agencies, classified newspaper advertisements, and Internet postings, among others sources. When a lead is identified by the management entity, the lead may be evaluated to determine whether the lead is a new lead or an old lead, an old lead being a lead that has already been handled by a sales associate in a previous occasion. If the lead is an old lead, the lead may be directly assigned to a sales associate that already handled that lead. Also, when a lead is an old lead, a determination may be made about whether the lead has been handled during a period of time that is too far in the past such as, for example, more than six months, in which case the old lead may be designated as a new lead. When a lead is a new lead, the lead is made available for auction as discussed below. Alternatively, according to various aspects of the present invention, all leads, old and new, may be made available as discussed below.

Once identified, the leads are made available by a managing entity for bidding by sales associates 220 via a communication platform such as, for example, a secure Internet web site or other network, such as a local area network (LAN) or wide area network (WAN), via the telephone, or other communication platform including person-to-person interaction. It should be noted that not all sales associates may have access to the leads available for bidding. According to aspects of the present invention, sales associates may have to register, log in to the platform such as, for example, a website, and/or obtain a password to access the leads available for bidding. Payment of a fee may also be required for access to the platform such as, for example, the website. Alternatively, access to the platform and to the information made available on the platform may be free of charge. Further, sales associates may have access to the leads based on the states or geographic areas where the sales associates are licensed.

In the case where the platform is a website, once an sales associate has logged in to the website, the sales associate may be able to view some or all qualifying leads including, for example, information regarding the type of property a lead is interested in, e.g., residential or commercial property, the price of the property for sale/rental, the highest current bid on the opportunity to explore the property, time left for the lead to expire, and whether any buyers have expressed an interest in the property, among other relevant information. According to aspects of the present invention, the information about interested buyers may include, for example, an identifier for the buyer such as, for example, the buyer's first name, the buyer's last name, both the buyer's first and last names, or a nickname, without further contact information so that the sales associate may not be able to contact the interested buyer directly without first having won the opportunity of exploring the lead.

On FIG. 2, bids are received 230. According to aspects of the present invention, the bids may be in the form of a percentage of the sales associate's commission in addition to the normally agreed commission splits between the sales associate and the agency or brokerage firm, and may be payable upon successful completion of the real estate transaction on the lead. However, it should be noted that the bids may also take the form of a flat fee and/or may be payable in advance in part or in full, for example. Further, there may be a minimum initial bid, such as 5% of the sales associate's commission, for example, and there may be a specific increment for making bids subsequent to the initial bid, such as no less than 1% of the commission, for example. According to other aspects of the invention, when a sales associate places a bid on a particular lead, the bid being a percentage amount of the value of the property, article of commerce or commodity, for example, any subsequent bids placed by that sales associate on the same lead for other properties or commodities may have to be of the same percentage amount. However, any new bids placed on other leads by the same sales associate may have a different percentage amount.

In accordance with aspects of the present invention, a sales associate may also be able to specify a maximum percentage of commission the sales associate is willing to pay. For example, a sales associate may put in a current bid of 10% for a given opportunity and a maximum bid of 30%. If a sales associate places a maximum bid of 30%, for example, because leads may be made available on the marketplace or communication platform for a specific period of time only (e.g., a lead may expire 60 minutes from the time it becomes available, or 15 minutes from the time a first bid is placed), even if the highest bid was, e.g., 29% at the expiration of the period of time, the sales associate that placed a maximum bid of 30% will win the lead because no bids over 30% were placed. It should be noted that the maximum bid amount may be set at any percentage of commission, or at any set amount.

In accordance with aspects of the present invention, a sales associate may be able to view or otherwise access via a user interface, for example, how much time remains before a lead expires, and what is the highest current bid on the lead. The sales associate may have the ability to modify the sales associate's original bid before expiration of the period of time, according to various aspects of the invention.

Moreover, in accordance with aspects of the present invention, one or more sales associates may be provided with, for example, a “buy it now” option with a specified amount of commission, which ensures that the lead is purchased immediately if a sales associate matches the commission amount specified in the “buy it now” option. For example, if the “buy it now” price is set at 20% of commission, any sales associate who selects the “buy it now” option and is willing to pay 20% of commission may be the immediate winner of the lead, provided that no other bid has been received that is higher than 20%. Thus, if no other bid has been received that is higher than 20%, the process ends regardless of whether the period of time for the lead has expired. It should be noted that the “buy it now” price may be set at any percentage of commission or other set amount, and may have an upper limit of 50% of commission. According to various aspects, if the bid amount exceeds 50% of commission, then the “buy it now” option is no longer available. According to various aspects of the current invention, if a sales associates offer to pay more than the amount specified in the “buy it now” option, then that amount becomes the new “buy it now” amount and that sales associate wins the lead immediately.

Next, the process determines whether a “buy it now” offer has been received as the highest bid in 240. If a “buy it now” offer has been received as the highest bid, then the sales associate making the “buy it now” offer wins the auction, the lead is assigned to the winning sales associate, and details about the lead are provided to the winning sales associate in 270 via a communication such as, for example, an e-mail communication. Conversely, if none of the bids received are equal to or greater than the “buy it now” offer, then the process determines whether the lead has expired 250. If the lead has not expired, then the process returns to making the leads available for bidding 220. On the other hand, if the lead has expired, then the highest bid from the bids received during the predetermined period of time for the lead is determined 260. Next, the lead is assigned to the winning sales associate 270, and details about the lead may be provided to the winning sales associate via a communication such as, for example, an e-mail communication or online on the website within the system.

In accordance with aspects of the present invention, the lead, for example, the interested buyer, may be further contacted within a set period of time, such as two or three days after the lead has been assigned to the winning sales associate, in order to ensure that the winning sales associate is following up on the lead. According to various aspects of the invention, the lead may be contacted by, for example, an administrator. Accordingly, if the winning sales associate fails to follow up with the lead within another set period of time, such as a week, then the winning sales associate may be informed that the winning sales associate has lost the bid, and the lead is made available for bidding on the communication platform, such as, for example, the website. Information about whether sales associates actually follow up on leads they have won may thus be compiled, sales associates may be graded on the basis of their ability to follow up on leads, and sales associates with low grades may be denied access to available bids if they fail to follow up on leads they won on a regular basis.

In accordance with aspects of the present invention, the system may also determine whether the percentage of commission or other fee that was promised by the winning sales associate has in fact been provided by the winning sales associate upon successful completion of the transaction on the lead. According to various aspects, an incentive may be provided to winning sales associates to pay the promised percentage of commission or other fee within a predetermined period of time, such as one week, after the successful completion of the transaction on the lead. After expiration of the predetermined period of time for providing payment, a penalty, such as a fine or public notice, may be imposed to sales associates who have not provided the agreed upon payment.

According to various aspects of the invention, a referral commission may be owed by the winning sales associate to the managing entity. For example, the referral commission may be a percentage of the winning bid. Payment of the referral commission may be performed once the transaction between the sales associate and the lead has been closed, and may be owed within a few days of the settlement of the transaction, such as two or three days. If the winning sales associate does not provide full payment of the referral commission, then the managing entity may request a higher payment, such as two or more times the amount of the original referral commission.

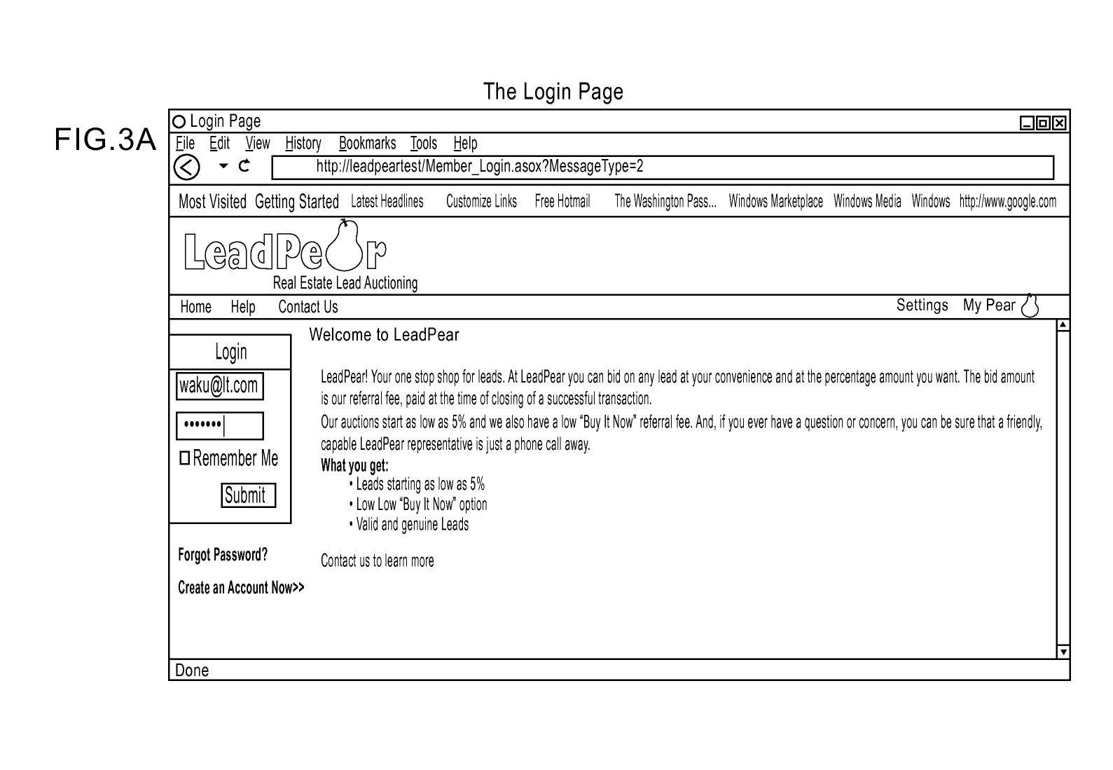

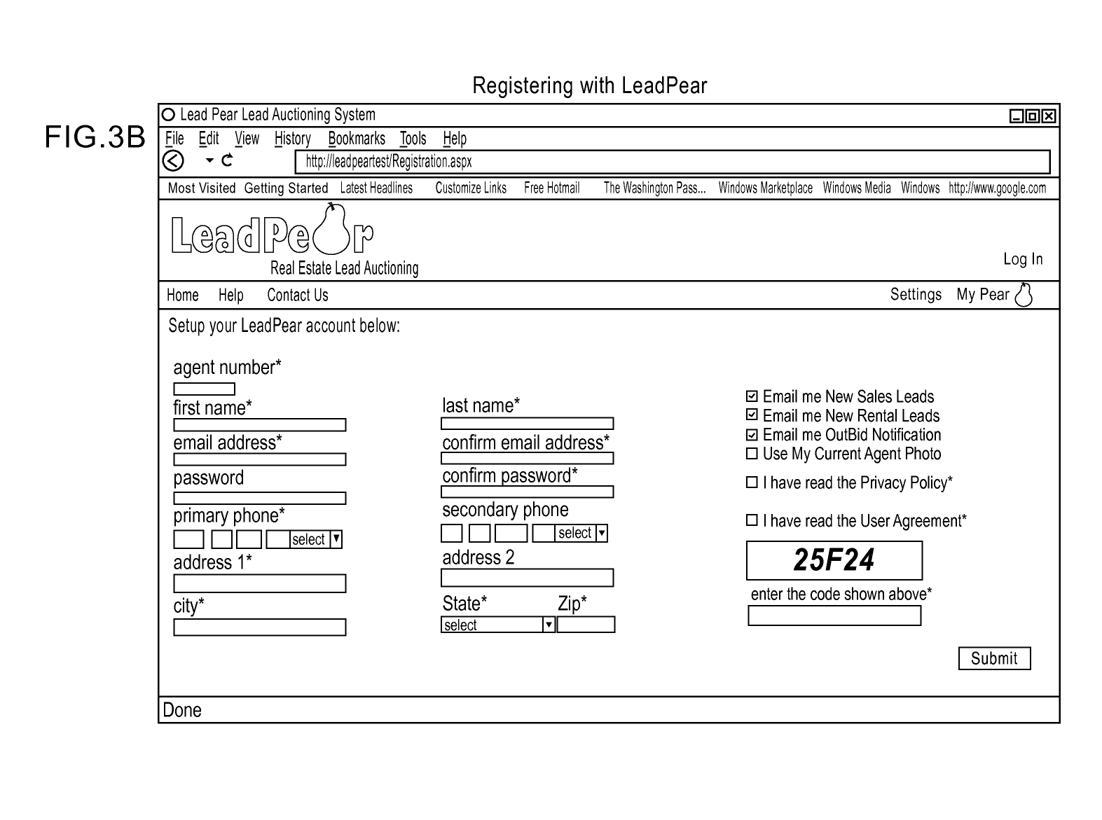

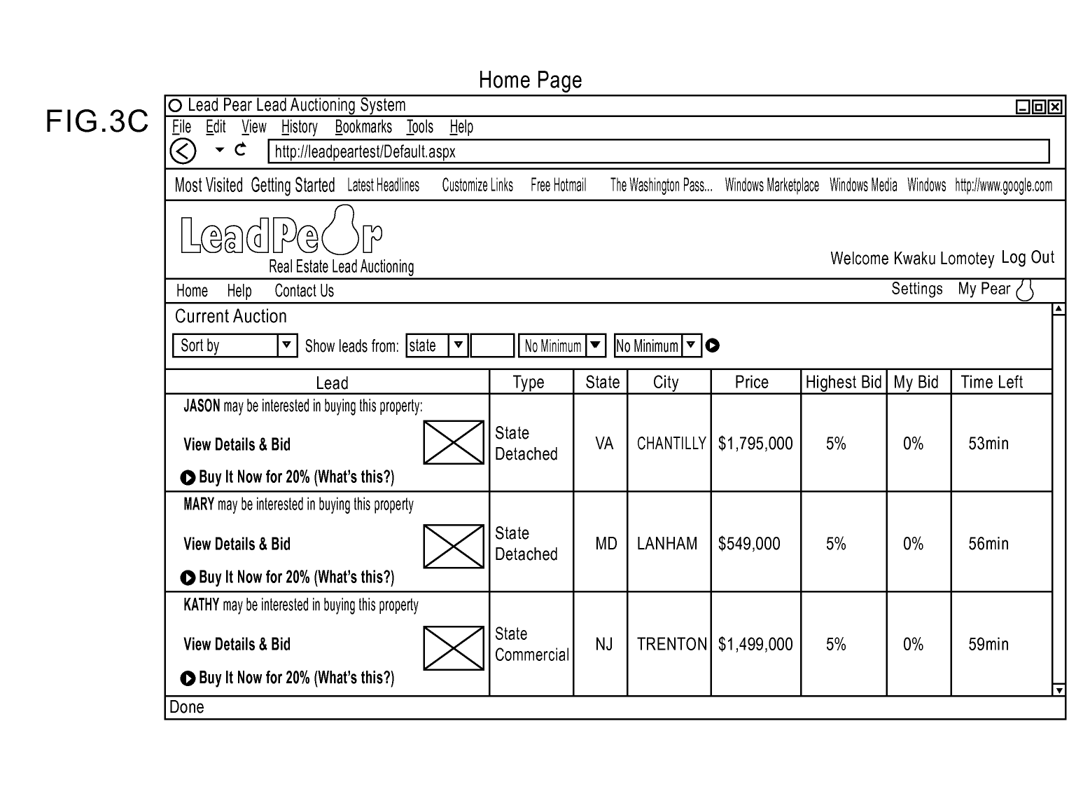

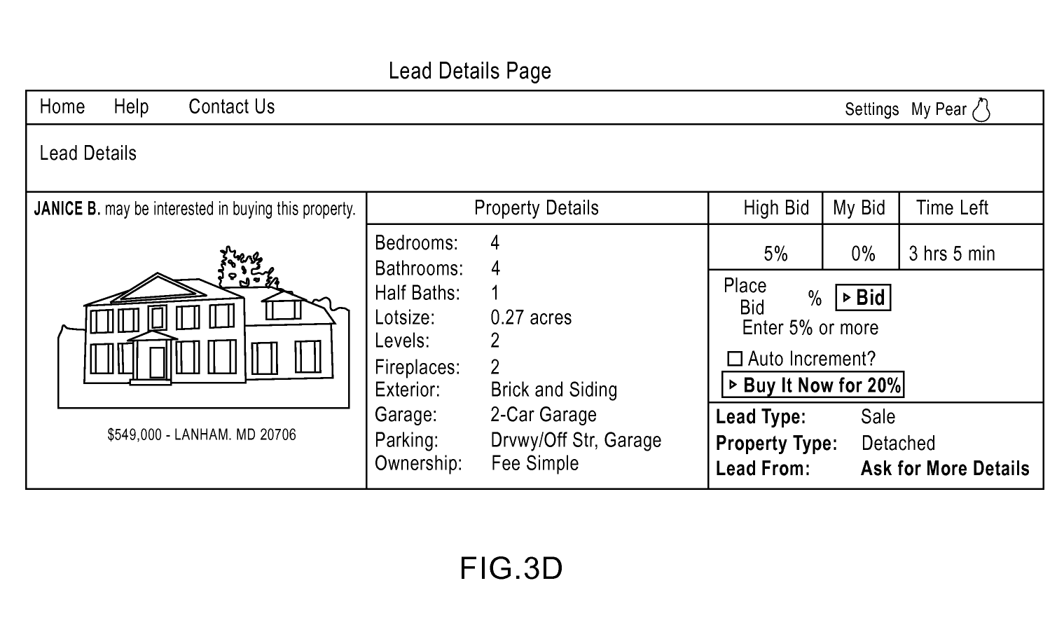

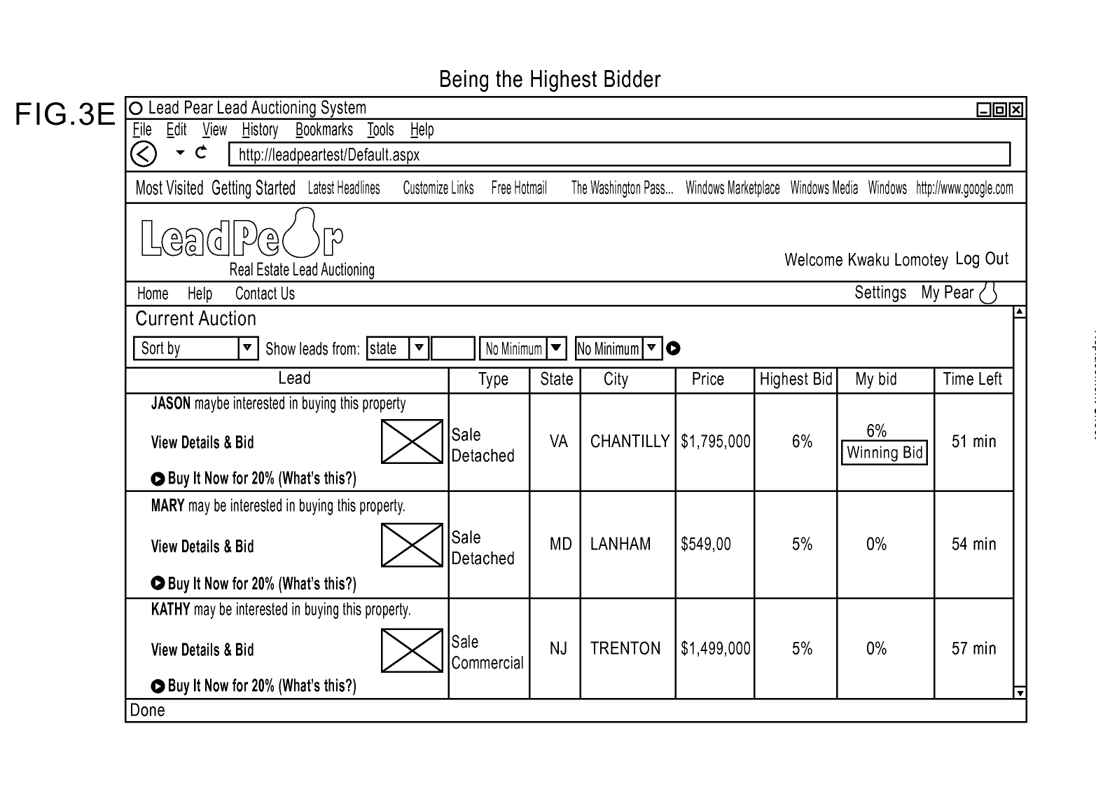

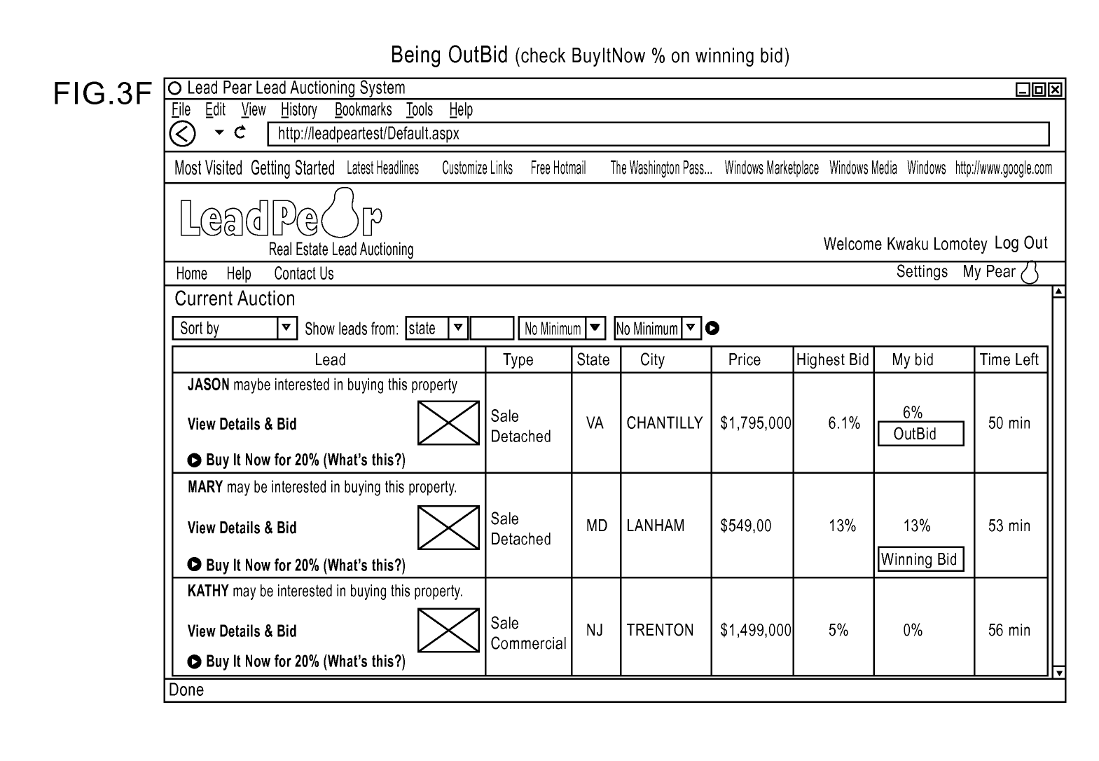

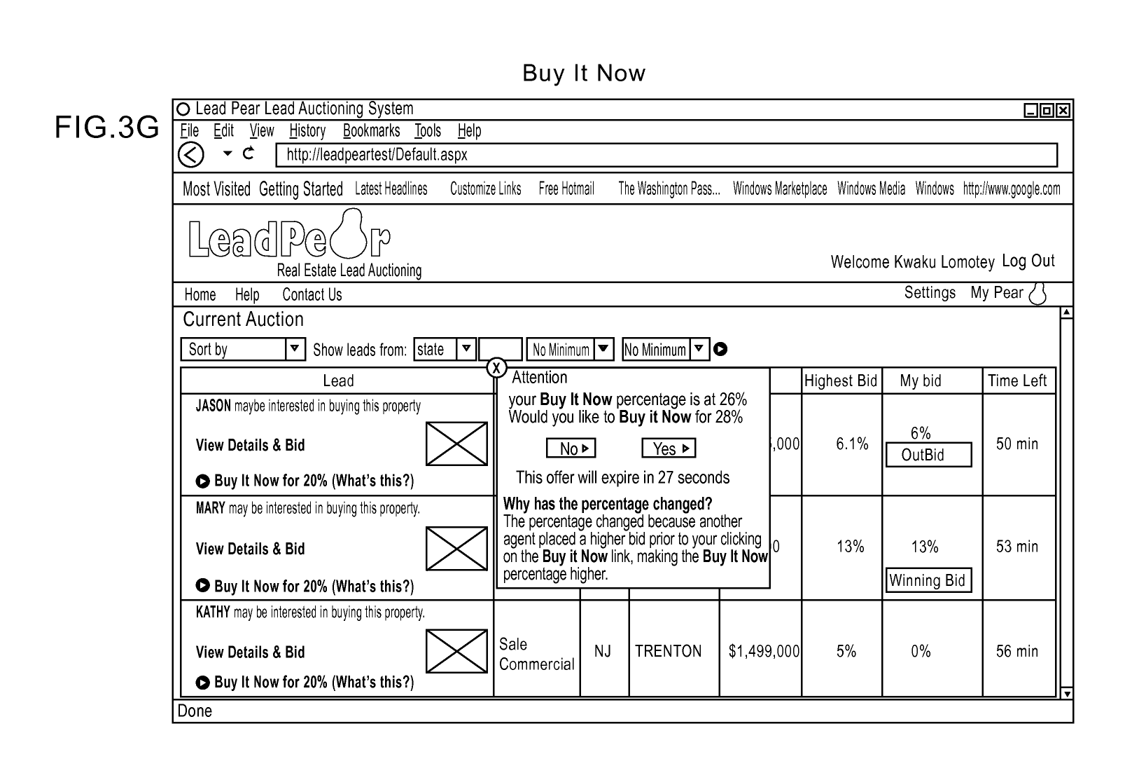

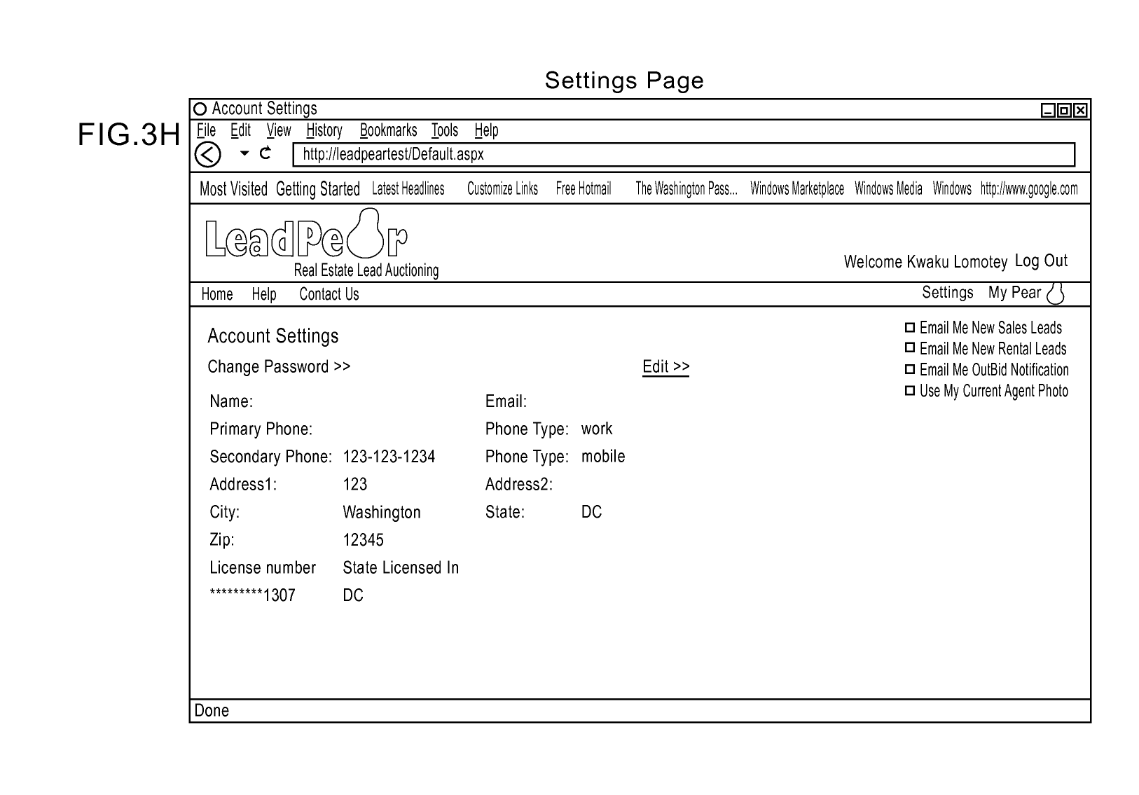

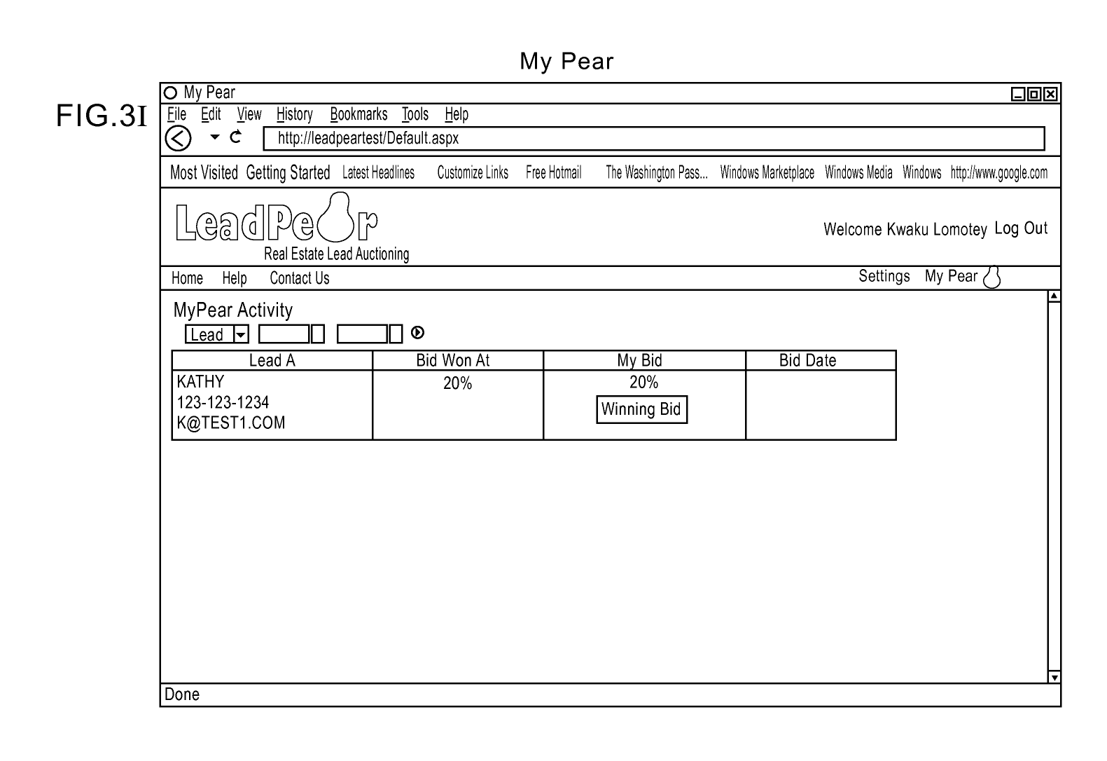

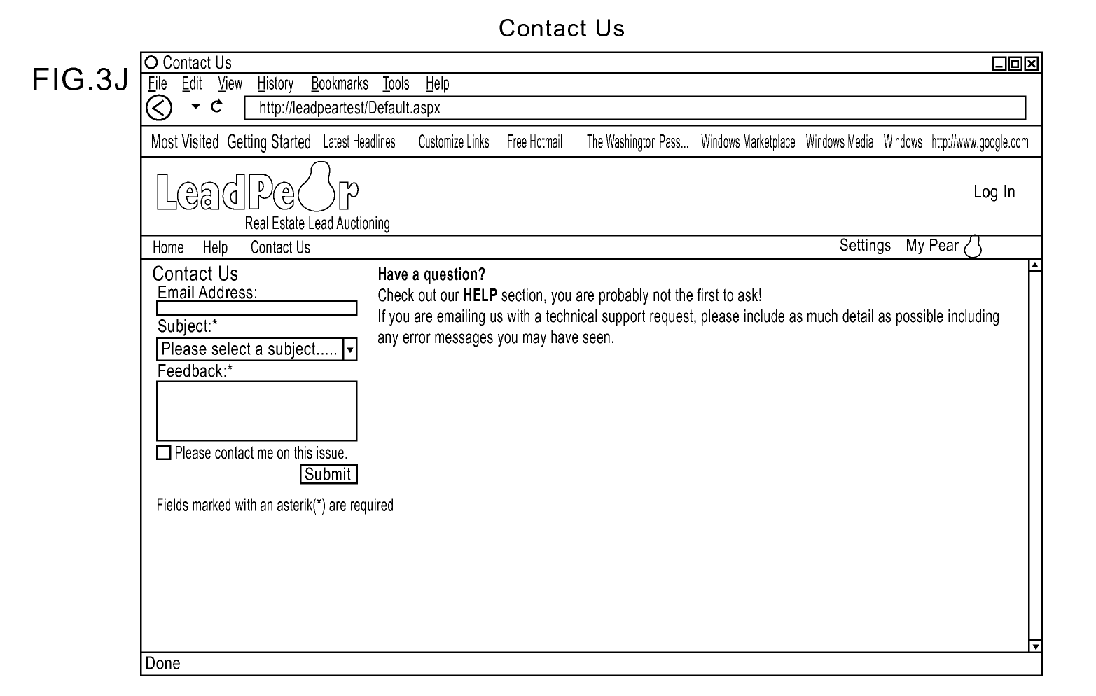

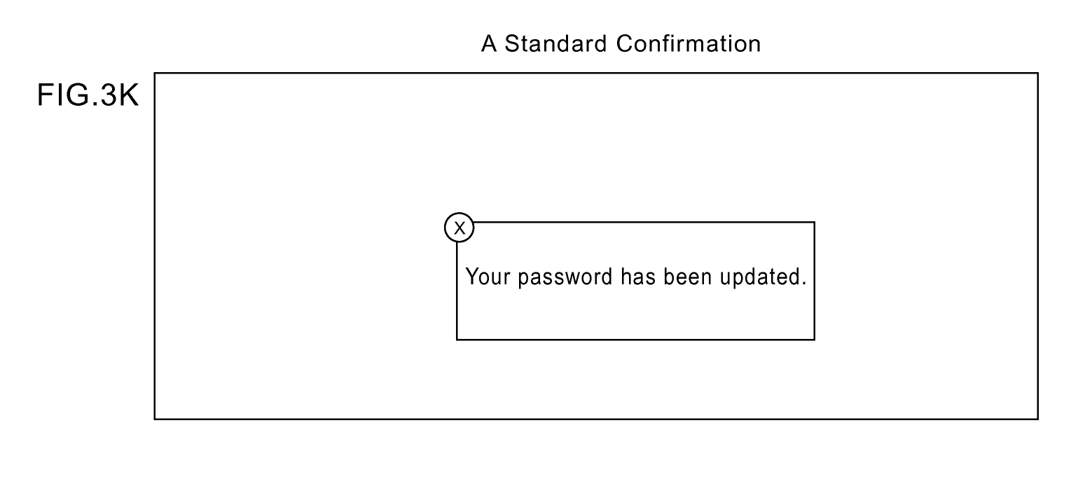

Referring now to FIG. 3A, therein shown is an exemplary GUI screen showing a login page for sales associates that would like to access qualifying bids. In the exemplary aspect illustrated in FIG. 3A, the communication platform is a website accessible by a sales associate via a login and a password. Aspects of the present invention offer functionality whereby the credentials of a sales associate may be stored and retrieved during subsequent logins, so that the sales associate does not need to enter the sales associate's credentials at each login.

Referring now to FIG. 3B, therein shown is an exemplary account registration and activation GUI screen, in accordance with aspects of the present invention where the communication platform is a website. For example, sales associates may be required to register and activate their accounts prior to using the system. For example, registration may include entering the sales associate's contact information and/or validating the sales associate's license. Upon completion, a sales associate may receive notification via, for example, e-mail, regular mail, voicemail or other messaging means, to activate the account of the sales associate.

Referring now to FIG. 3C, therein shown is an exemplary GUI screen showing a list of leads and some details on the leads such as price, location, highest bid, bid of the specific sales associate who has logged in, and time left on the bid. However, other details may be made available to the sales associate. According to various aspects of this invention, the list of leads may depend upon the states/locations where the sales associate is registered so that the sales associate may be able to view only leads within the areas where the sales associate is licensed.

FIGS. 3D-3K illustrate additional exemplary GUI screens, in accordance with aspects of the present invention.

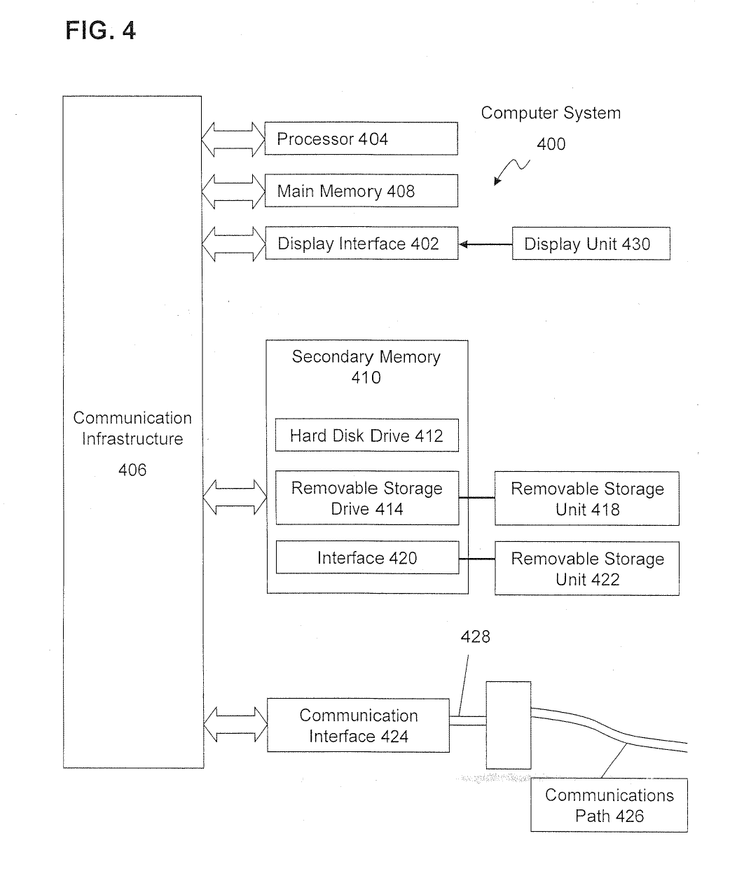

The present invention may be implemented using a combination of hardware, software and firmware in a computer system. In an aspect of the present invention, the invention is directed toward one or more computer systems capable of carrying out the functionality described herein. An example of such a computer system 400 is shown in FIG. 4.

Computer system 400 includes one or more processors, such as processor 404. The processor 404 is connected to a communication infrastructure 406 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 400 can include a display interface 402 that forwards graphics, text, and other data from the communication infrastructure 406 (or from a frame buffer not shown) for display on a display unit 430. Computer system 400 also includes a main memory 408, preferably random access memory (RAM), and may also include a secondary memory 410. The secondary memory 410 may include, for example, a hard disk drive 412 and/or a removable storage drive 414, representing a floppy disk drive, a magnetic tape drive, an optical disk drive, etc. The removable storage drive 414 reads from and/or writes to a removable storage unit 418 in a well-known manner. Removable storage unit 418, represents a floppy disk, magnetic tape, optical disk, etc., which is read by and written to removable storage drive 414. As will be appreciated, the removable storage unit 418 includes a computer usable storage medium having stored therein computer software and/or data.

Alternative aspects of the present invention may include secondary memory 410 and may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428, which may be electronic, electromagnetic, optical or other signals capable of being received by communications interface 424. These signals 428 are provided to communications interface 424 via a communications path (e.g., channel) 426. This path 426 carries signals 428 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 480, a hard disk installed in hard disk drive 470, and signals 428. These computer program products provide software to the computer system 400. The invention is directed to such computer program products.

Computer programs (also referred to as computer control logic) are stored in main memory 408 and/or secondary memory 410. Computer programs may also be received via communications interface 424. Such computer programs, when executed, enable the computer system 400 to perform the features of the present invention, as discussed herein. In particular, the computer programs, when executed, enable the processor 410 to perform the features of the present invention. Accordingly, such computer programs represent controllers of the computer system 400.

In an aspect of the present invention where the invention is implemented using software, the software may be stored in a computer program product and loaded into computer system 400 using removable storage drive 414, hard drive 412, or communications interface 420. The control logic (software), when executed by the processor 404, causes the processor 404 to perform the functions of the invention as described herein. In another aspect of the present invention, the invention is implemented primarily in hardware using, for example, hardware components, such as application specific integrated circuits (ASICs). Implementation of the hardware state machine so as to perform the functions described herein will be apparent to persons skilled in the relevant art(s).

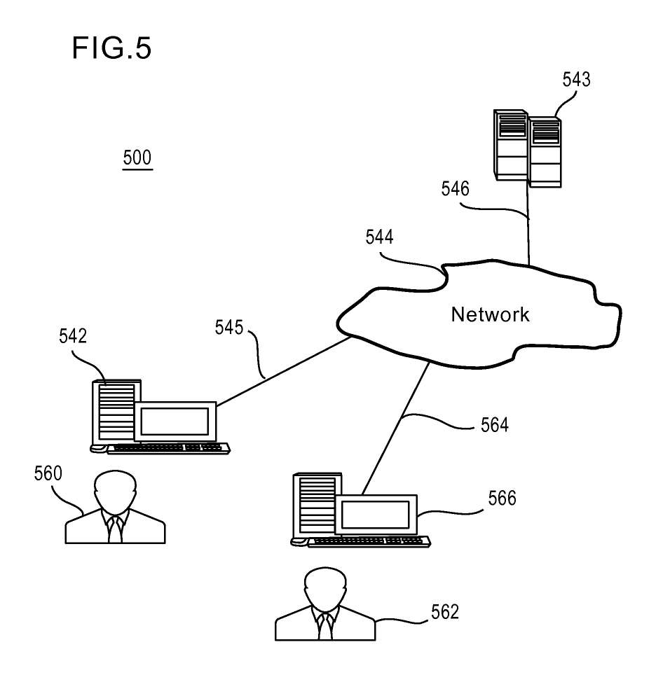

FIG. 5 shows a communication system 500 usable in accordance with the present invention. The communication system 500 includes one or more accessors 560, 562 (also referred to interchangeably herein as one or more “users”) and one or more terminals 542, 566. In one aspect, data for use in accordance with the present invention is, for example, input and/or accessed by accessors 560, 564 via terminals 542, 566, such as personal computers (PCs), minicomputers, mainframe computers, microcomputers, telephonic devices, or wireless devices, such as personal digital assistants (“PDAs”) or a hand-held wireless devices coupled to a server 543, such as a PC, minicomputer, mainframe computer, microcomputer, or other device having a processor and a repository for data and/or connection to a repository for data, via, for example, a network 544, such as the Internet or an intranet, and couplings 545, 546, 564. The couplings 545, 546, 564 include, for example, wired, wireless, or fiberoptic links. In another aspect, the method and system of the present invention operate in a stand-alone environment, such as on a single terminal.

While this invention has been described in conjunction with the exemplary aspects outlined above, various alternatives, modifications, variations, improvements, and/or substantial equivalents, whether known or that are or may be presently unforeseen, may become apparent to those having at least ordinary skill in the art. Accordingly, the exemplary aspects of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A method for organizing an auction, the method comprising instructions for:
receiving one or more leads via the processor, wherein the one or more leads comprise information relative to at least one commodity;
making information relative to the one or more leads available to one or more parties;
receiving one or more bids from at least one of the one or more parties;
determining a winning bid and a winning party, the winning party being one of the one or more parties; and
assigning the winning bid to the winning party.

2. The method of claim 1, wherein the one or more leads comprise at least one of a potential buyer of the commodity, a potential renter of the commodity, and a facilitator.

3. The method of claim 1, wherein the one or more parties comprise at least a sales associate of the commodity.

4. The method of claim 1, wherein the one or more leads are received via at least one of classified listings, advertisements, public postings and internet postings.

5. The method of claim 1, wherein the one or more leads are made available over a communication platform.

6. The method of claim 5, wherein the communication platform comprises at least one of a website, a telephone communication, a wide area network, a local area network, an electronic communication, a marking device, an audio device, and a visual device.

7. The method of claim 3, wherein the at least one sales associate is a selected sales associate based on at least one of geographic location, licensing status, registration status, and payment of a fee.

8. The method of claim 1, wherein the at least one commodity comprises a real estate property.

9. The method of claim 7, wherein the registration status comprises providing login information and a password by the at least one sales associate.

10. The method of claim 1, wherein the information relative to the leads comprises at least one of price, location, vendor, highest bid, lowest bid, time left before expiration of the lead, indication of interest by any potential buyer or renter, identifier of the potential buyer or renter.

11. The method of claim 10, wherein the identifier of the potential buyer or renter comprises one of a first name, a last name, a random alphanumeric character, and a nickname.

12. The method of claim 1, wherein the received one or more bids comprise at least one of a flat fee, a percentage of a sale price of the commodity and a commission for the sale of the commodity.

13. The method of claim 1, wherein making the information available comprises providing at least one of an initial bid, a bid increment, a highest bid, a time period during which the lead is made available and a remaining time period during which the lead is made available.

14. The method of claim 13, wherein the highest bid comprises a bid that is accepted if matched by at least one of the one or more parties even when the time period has not elapsed.

15. The method of claim 14, wherein a received bid that is higher than the highest bid is considered to be the highest bid when accepted by at least one of the one or more parties even when the time period has not elapsed.

16. The method of claim 13, wherein determining the winning bid comprises designating the winning bid as the highest bid when the time period has elapsed.

17. The method of claim 1, further comprising determining whether the winning party has provided payment of the winning bid after a first predetermined period of time.

18. The method of claim 17, wherein when the winning party has not provided payment of the winning bid, the lead is made available to other ones of the one or more parties after a second predetermined period of time.

19. The method of claim 18, wherein the winning party is assigned a low grade, and the low grade becomes part of a record of the one of the one or more parties.

20. A system for organizing an auction, the system comprising:
a module for receiving one or more leads via the processor, wherein the one or more leads comprise information relative to at least one commodity;
a module for making information relative to the one or more leads available to one or more parties;
a module for receiving one or more bids from at least one of the one or more parties;
a module for determining a winning bid and a winning party, the winning party being one of the one or more parties; and
a module for assigning the winning bid to the winning party.

21. A system for organizing an auction, the system comprising:
a processor;
a user interface functioning via the processor; and
a repository accessible by the processor; wherein
one or more leads are received via the processor, wherein the one or more leads comprise information relative to at least one commodity;
information relative to the one or more leads is made available to one or more parties;
one or more bids are received from at least one of the one or more parties;
a winning bid and a winning party, the winning party being one of the one or more parties, are determined; and
the winning bid is assigned to the winning party.

22. A computer program product comprising a computer usable medium having control logic stored therein for causing a computer to organize an auction, the control logic comprising:
first computer readable program code means for receiving one or more leads via the processor, wherein the one or more leads comprise information relative to at least one commodity;
second computer readable program code means for making information relative to the one or more leads available to one or more parties;
third computer readable program code means for receiving one or more bids from at least one of the one or more parties;
fourth computer readable program code means for determining a winning bid and a winning party, the winning party being one of the one or more parties; and
fifth computer readable program code means for assigning the winning bid to the winning party.
